(19) United States
(12) Patent Application Publication
(10) Pub. No.: US 2024/0334523 A1
(43) Pub. Date: Oct. 3, 2024

(54) METHOD AND APPARATUS FOR MANAGING BEAMS IN IDLE/INACTIVE STATE OF NETWORK CONTROLLED REPEATER IN WIRELESS COMMUNICATION SYSTEM

(71) Applicant: Samsung Electronics Co., Ltd., Suwon-si (KR)

(72) Inventors: June HWANG, Suwon-si (KR); Beomsik BAE, Suwon-si (KR); Byounghoon JUNG, Suwon-si (KR)

(21) Appl. No.: 18/621,990

(22) Filed: Mar. 29, 2024

(30) Foreign Application Priority Data
Mar. 30, 2023 (KR) 10-2023-0042211

(51) Int. Cl. H04W 76/19; H04B 7/155

(52) U.S. Cl. CPC H04W 76/19; H04B 7/15557

(57) ABSTRACT

The disclosure relates to a 5G or 6G communication system for supporting a higher data transmission rate. A method performed by a network-controlled repeater (NCR) node in a wireless communication system is provided. The method includes determining, by an NCR-mobile termination (NCR-MT) entity of the NCR node, degradation of a backhaul link beam, while the NCR-MT entity is in inactive state, based on the determination, ceasing, by an NCR-forwarding (NCR-Fwd) entity of the NCR node, amplifying and forwarding of radio frequency (RF) signals, and performing, by the NCR-MT entity, a connection resume procedure.

### CROSS-REFERENCE TO RELATED APPLICATION(S)

This application is based on and claims priority under 35 U.S.C. § 119 (a) of a Korean patent application number 10-2023-0042211, filed on Mar. 30, 2023, in the Korean Intellectual Property Office, the disclosure of which is incorporated by reference herein in its entirety.

### BACKGROUND

### 1. Filed

The disclosure relates to a wireless communication system. More particularly, the disclosure relates to a method and an apparatus for managing beams in an idle or inactive state of a network controlled repeater (NCR).

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of processing the case where beam failure of a backhaul beam (or a backhaul link beam) occurs in an idle or inactive state of a network controlled repeater (NCR).

Additional aspects will be set forth in part in the description which follows and, in part, will be apparent from the description, or may be learned by practice of the presented embodiments.

In accordance with an aspect of the disclosure, a method performed by a network-controlled repeater (NCR) node in a wireless communication system is provided. The method includes determining, by an NCR-mobile termination (NCR-MT) entity of the NCR node, degradation of a backhaul link beam, while the NCR-MT entity is in inactive state, based on the determination, ceasing, by an NCR-forwarding (NCR-Fwd) entity of the NCR node, amplifying and forwarding of radio frequency (RF) signals, and performing, by the NCR-MT entity, a connection resume procedure.

In accordance with another aspect of the disclosure, a method performed by an NCR-MT entity in a wireless communication system is provided. The method includes determining degradation of a backhaul link beam, while the NCR-MT entity is in inactive state, and performing a connection resume procedure, wherein amplifying and forwarding of RF signals is ceased based on the determination.

In accordance with another aspect of the disclosure, an NCR node in a wireless communication system is provided. The NCR node includes a transceiver a controller coupled with the transceiver. The controller is configured to determine, by an NCR-MT entity of the NCR node, degradation of a backhaul link beam, while the NCR-MT entity is in inactive state, based on the determination, cease, by an NCR-Fwd entity of the NCR node, amplifying and forwarding of RF signals, and perform, by the NCR-MT entity, a connection resume procedure.

In accordance with another aspect of the disclosure, an NCR-MT entity in a wireless communication system is provided. The NCR-MT entity includes a transceiver and a controller coupled with the transceiver. The controller is configured to determine degradation of a backhaul link beam, while the NCR-MT entity is in inactive state, and perform a connection resume procedure, wherein amplifying and forwarding of RF signals is ceased based on the determination.

In accordance with another aspect of the disclosure, one or more non-transitory computer-readable storage media storing one or more computer programs including computer-executable instructions that, when executed by one or more processors of an NCR node, cause the NCR node to perform operations are provided. The operations include determining, by an NCR-MT entity of the NCR node, degradation of a backhaul link beam, while the NCR-MT entity is in inactive state, based on the determination, ceasing, by an NCR-Fwd entity of the NCR node, amplifying and forwarding of RF signals, and performing, by the NCR-MT entity, a connection resume procedure.

According to an embodiment of the disclosure, it is possible to efficiently control and operation beams of an NCR.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a typical long term evolution (LTE) system according to an embodiment of the disclosure;

FIG. 2 illustrates a radio protocol structure in a typical LTE system according to an embodiment of the disclosure;

FIG. 3 illustrates a structure of a next-generation base station in a wireless communication system according to an embodiment of the disclosure;

FIG. 4 illustrates a radio protocol structure of a next-generation mobile communication system according to an embodiment of the disclosure;

FIG. 5 is a block diagram illustrating the internal structure of a UE according to an embodiment of the disclosure;

FIG. 6 is a block diagram illustrating the configuration of an NR base station according to an embodiment of the disclosure;

FIG. 7 illustrates the configuration of a network controlled repeater according to an embodiment of the disclosure;

FIG. 8 illustrates a scenario where a backhaul beam is blocked according to an embodiment of the disclosure;

FIG. 9 illustrates method 1-1 according to an embodiment of the disclosure;

FIG. 10A illustrates method 1-2 according to an embodiment of the disclosure;

FIG. 10B illustrates method 1-2 according to an embodiment of the disclosure; and

FIG. 11 illustrates method 2 according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or long term evolution advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description of the disclosure, terms and names defined in 5G system (5GS) and NR standards, which are the latest standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

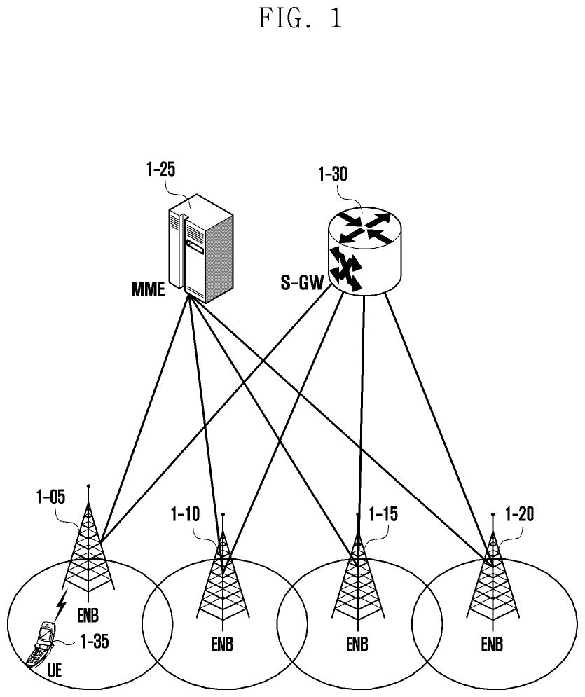

FIG. 1 illustrates a structure of a typical LTE system according to an embodiment of the disclosure.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05, 1-10, 1-15, and 1-20 and the S-GW 1-30.

In FIG. 1, the ENBs 1-05 to 1-20 may correspond to a conventional node B in a UMTS system. The ENBs may be connected to the UE 1-35 through a radio channel, and perform more complicated roles than the conventional node Bs. In the LTE system, since all user traffic including real-time services, such as voice over IP (VoIP) via the Internet protocol, may be serviced through a shared channel. Thus, a device that collects state information, such as buffer states, available transmit power states, and channel states of UEs, and performs scheduling accordingly is required, and the ENBs 1-05, 1-10, 1-15, and 1-20 may serve as the device. In general, one ENB may control multiple cells. For example, in order to implement a transfer rate of 100 Mbps, the LTE system may use orthogonal frequency division multiplexing (hereinafter referred to as OFDM) as a radio access technology in a bandwidth of, for example, 20 MHz. Furthermore, the next-generation mobile communication system may employ an adaptive modulation & coding (AMC) scheme for determining a modulation scheme and a channel coding rate according to a channel state of a UE. The S-GW 1-30 is a device that provides a data bearer, and may generate or remove a data bearer under the control of the MME 1-25. The MME 1-25 is responsible for various control functions as well as a mobility management function for a UE, and may be connected to multiple base stations.

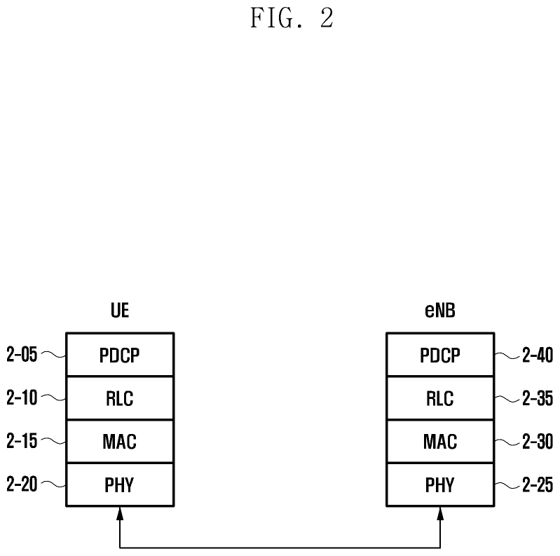

FIG. 2 illustrates a radio protocol structure in a typical LTE system according to an embodiment of the disclosure.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 in each of a UE and an ENB. The PDCP 2-05 or 2-40 may serve to perform operations, such as IP header compression/reconstruction. The main functions of the PDCP 2-05 or 2-40 may be summarized as follows.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception)
Duplicate detection of lower layer service data units (SDUs) at PDCP re-establishment procedure for RLC AM)
Retransmission of PDCP SDUs at handover and, for split bearers in DC, of PDCP PDUs at PDCP data-recovery procedure, for RLC AM)
Ciphering and deciphering
Timer-based SDU discard in uplink

The radio link control (RLC) 2-10 or 2-35 may reconfigure a PDCP protocol data unit (PDU) into an appropriate size to perform an automatic repeat request (ARQ) operation. The main functions of the RLC may be summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from physical layer on transport channels
Scheduling information reporting
Error correction through hybrid ARQ (HARQ)
Priority handling between logical channels of one UE
Priority handling between UEs by means of dynamic scheduling
MBMS service identification
Transport format selection
Padding

A physical layer 2-20 or 2-25 may perform operations of channel-coding and modulating upper layer data, generating the data into OFDM symbols, and transmitting the same through a radio channel, or demodulating the OFDM symbols received through the radio channel, channel-decoding the same, and delivering the same to the upper layer.

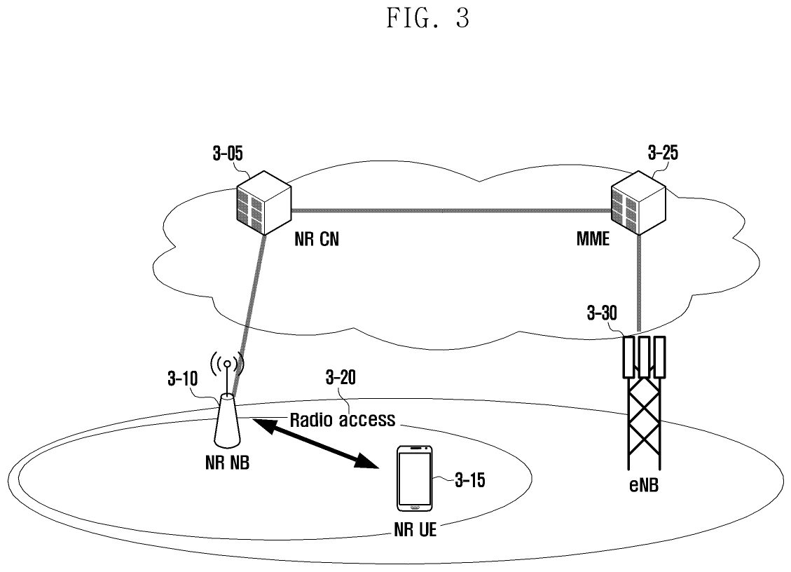

FIG. 3 illustrates a structure of a next-generation mobile communication system according to an embodiment of the disclosure.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10, the NR CN 3-05, and radio access network 3-20.

In FIG. 3, the NR gNB 3-10 may correspond to an evolved node B (eNB) of a conventional LTE system. The NR gNB 3-10 may be connected to the NR UE 3-15 through a radio channel and provide outstanding services as compared to a conventional node B. In the next-generation mobile communication system, since all user traffic may be serviced through a shared channel. Thus, a device that collects state information, such as buffer statuses, available transmit power states, and channel states of UEs, and performs scheduling accordingly is required, and the NR NB 3-10 may serve as the device. In general, one NR gNB 3-10 may control multiple cells. In order to implement ultrahigh-speed data transfer beyond the current LTE, the next-generation mobile communication system may provide a wider bandwidth than the existing maximum bandwidth. In addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (AMC) scheme for determining a modulation scheme and a channel coding rate according to a channel state of a UE. The NR CN 3-05 may perform functions such as mobility support, bearer configuration, and quality of service (QoS) configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 3-25 via a network interface. The MME may be connected to an eNB 3-30 that is an LTE base station.

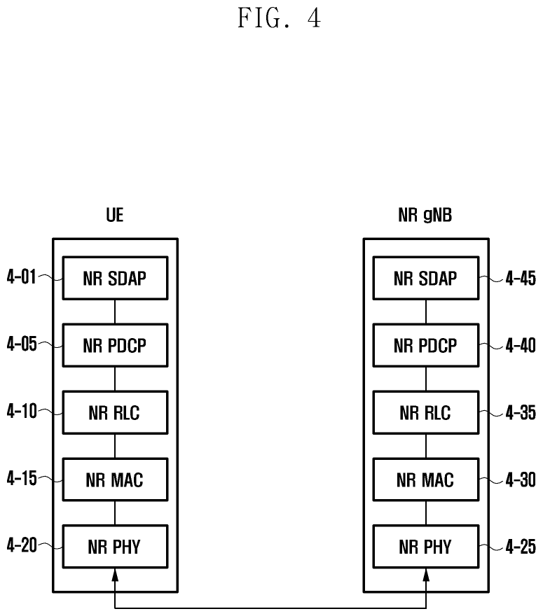

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 in each of a UE and an NR base station.

The main functions of the NR SDAPs 4-01 and 4-45 may include some of the following functions.
Transfer of user plane data
Mapping between a QoS flow and a data radio bearer (DRB) for both DL and UL
Marking QoS flow ID in both DL and UL packets
Reflective QoS flow to DRB mapping for UL SDAP PDUs

Whether to use a header of the SDAP layer device, or whether to use a function of the SDAP layer device may be configured for the UE with respect to the SDAP layer device through an RRC message for each PDCP layer device, each bearer, or each logical channel. In a case where an SDAP header is configured, a non access stratum (NAS) QoS reflective configuration one-bit indicator (NAS reflective QoS) and an As QoS reflective configuration one-bit indicator (As reflective QoS) of the SDAP header may indicate the terminal to update or reconfigure mapping information relating to a QoS flow and a data bearer for uplink and downlink. The SDAP header may include QoS flow ID information indicating the QoS. The QoS information may be used as data processing priority, scheduling information, etc. for smoothly supporting the service.

The main functions of the NR PDCPs 4-05 and 4-40 may include some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device may refer to a function of reordering PDCP PDU received from a lower layer in an order based on PDCP sequence numbers (SNs). The reordering of the NR PDCP device may include a function of transferring data to a higher layer according to a rearranged order, may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, and may include a function of requesting retransmission of lost PDCP PDUs.

The main functions of the NR RLC 4-10 and 4-35 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery function of the NR RLC device may refer to a function of successively delivering RLC SDUs received from the lower layer to the upper layer. If one original RLC SDU is divided into several RLC SDUs and the RLC SDUs are received, the in-sequence delivery function of the NR RLC device may include a function of reassembling the several RLC SDUs and transferring the reassembled RLC SDUs.

The in-sequence delivery function of the NR RLC device may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, and may include a function of requesting retransmission of lost RLC PDUs.

The in-sequence delivery function of the NR RLC device may include a function of, if there is a lost RLC SDU, sequentially transferring only RLC SDUs before the lost RLC SDU to an upper layer.

The in-sequence delivery function of the NR RLC device may include a function of, although there is a lost RLC SDU, if a predetermined timer has expired, sequentially transferring, to an upper layer, all the RLC SDUs received before the timer is started.

The in-sequence delivery function of the NR RLC device may include a function of, although there is a lost RLC SDU, if a predetermined timer has expired, sequentially transferring all the RLC SDUs received up to the current, to an upper layer.

The in-sequence delivery function of the NR RLC device may process RLC PDUs in a reception sequence (a sequence in which the RLC PDUs arrive, regardless of a sequence based on sequence numbers (out-of-sequence delivery)) and then transfer the processed RLC PDUs to the NR PDCP device.

In a case where the NR RLC device receives segments, the in-sequence delivery function of the NR RLC device may receive segments stored in a buffer or to be received in the future, reconfigure the segments to be one whole RLC PDU, process the RLC PDU, and then transfer the processed RLC PDU to the NR PDCP device.

The NR RLC layer may not include a concatenation function, but the concatenation function may be performed in the NR MAC layer or replaced with a multiplexing function of the NR MAC layer.

The above-mentioned out-of-sequence delivery function of the NR RLC device may refer to a function of immediately transferring RLC SDUs received from a lower layer, to an upper layer regardless of the order thereof. The out-of-sequence delivery function of the NR RLC device may include a function of, if one original RLC SDU is divided into several RLC SDUs and then the RLC SDUs are received, reassembling the several RLC SDUs and transferring the reassembled RLC SDUs. The out-of-sequence delivery function of the NR RLC device may include a function of storing an RLC sequence number (SN) or a PDCP sequence number (SN) of received RLC PDUs and arranging order to record lost RLC PDUs.

The NR MAC 4-15 or 4-30 may be connected to multiple NR RLC layer devices configured in one UE, and the main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

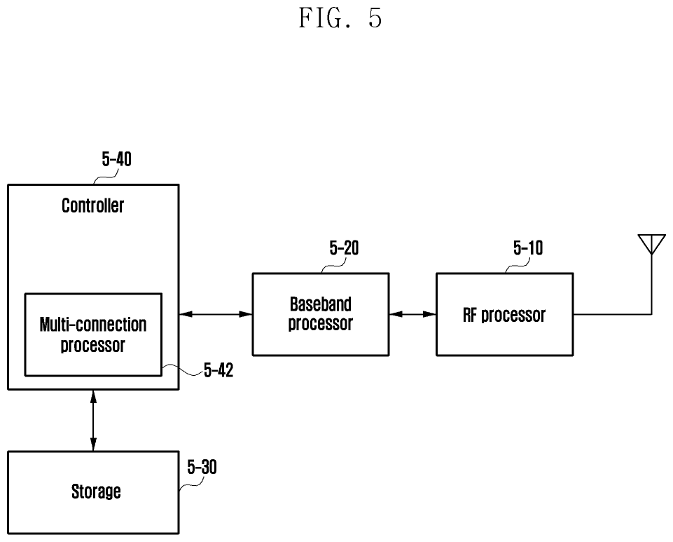

FIG. 5 is a block diagram illustrating the structure of a UE according to an embodiment of the disclosure.

Referring to FIG. 5, the UE includes a radio frequency (RF) processing unit 5-10, a baseband processing unit 5-20, a storage unit 5-30, and a controller 5-40.

The RF processing unit 5-10 performs a function of transmitting and receiving a signal through a radio channel such as converting or amplifying a band of the signal. That is, the RF processing unit 5-10 up-converts a baseband signal provided from the baseband processing unit 5-20 into an RF band signal, transmits the RF band signal through an antenna, and then down-converts the RF band signal received through the antenna into a baseband signal. For example, the RF processing unit 5-10 may include a transmission filter, a reception filter, an amplifier, a mixer, an oscillator, a digital-to-analog converter (DAC), an analog-to-digital converter (ADC), and the like. Although FIG. 5 illustrates only one antenna, the UE may include a plurality of antennas. The RF processing unit 5-10 may include a plurality of RF chains. Moreover, the RF processing unit 5-10 may perform beamforming. For the beamforming, the RF processing unit 5-10 may control a phase and a size of each of the signals transmitted/received through a plurality of antennas or antenna elements. The RF processing unit may perform MIMO and receive a plurality of layers when performing the MIMO operation.

The baseband processing unit 5-20 performs a function for a conversion between a baseband signal and a bitstream according to a physical layer standard of the system. For example, in data transmission, the baseband processing unit 5-20 generates complex symbols by encoding and modulating a transmission bitstream. Further, in data reception, the baseband processing unit 5-20 reconstructs a reception bitstream by demodulating and decoding a baseband signal provided from the RF processing unit 5-10. For example, in an orthogonal frequency-division multiplexing (OFDM) scheme, when data is transmitted, the baseband processing unit 5-20 generates complex symbols by encoding and modulating a transmission bitstream, maps the complex symbols to subcarriers, and then configures OFDM symbols through an inverse fast Fourier transform (IFFT) operation and a cyclic prefix (CP) insertion. Further, when data is received, the baseband processing unit 5-20 divides the baseband signal provided from the RF processing unit 5-10 in the unit of OFDM symbols, reconstructs the signals mapped to the subcarriers through a fast Fourier transform (FFT) operation, and then reconstructs a reception bitstream through demodulation and decoding.

The baseband processing unit 5-20 and the RF processing unit 5-10 may transmit and receive the signal as described above. Accordingly, each of the baseband processing unit 5-20 and the RF processing unit 5-10 may be called a transmitter, a receiver, a transceiver, or a communication unit. Further, at least one of the baseband processing unit 5-20 and the RF processing unit 5-10 may a plurality of communication modules to support a plurality of different radio access technologies. At least one of the baseband processing unit 5-20 and the RF processing unit 5-10 may include different communication modules to process signals in different frequency bands. For example, the different radio access technologies may include a wireless LAN (for example, IEEE 802.11) and a cellular network (for example, LTE). Further, the different frequency bands may include a super high frequency (SHF) (for example, 2.NRHz, NRhz) band and a millimeter (mm) wave (for example, 60 GHZ) band.

The storage unit 5-30 stores data such as a basic program, an application, configuration information, and the like for the operation of the UE. Particularly, the storage unit 5-30 may store information related to a second access node performing wireless communication through a second radio access technology. The storage unit 5-30 provides stored data according to a request from the controller 5-40.

The controller 5-40 controls the overall operation of the UE. For example, the controller 5-40 transmits and receives signals through the baseband processing unit 5-20 and the RF processing unit 5-10. Further, the controller 5-40 reads data in the storage unit 5-30 and reads the data. To this end, the controller 5-40 may include at least one processor. For example, the controller 5-40 may include a communication processor (CP) that performs a control for communication, and an application processor (AP) that controls a higher layer such as an application.

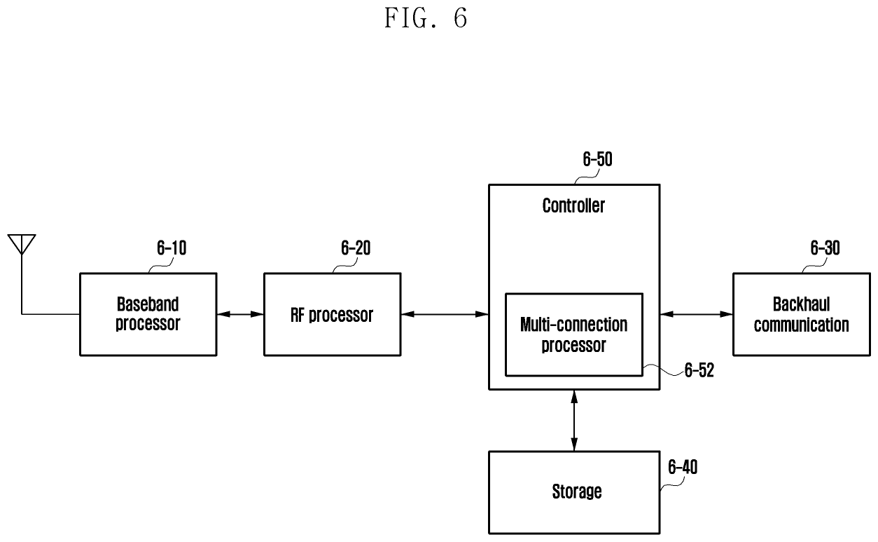

FIG. 6 is a block diagram illustrating the configuration of an NR base station according to an embodiment of the disclosure.

Referring to FIG. 6, the base station includes an RF processing unit 6-10, a baseband processing unit 6-20, a backhaul communication unit 6-30, a storage unit 6-40, and a controller 6-50.

The RF processing unit 6-10 performs a function of transmitting and receiving a signal through a radio channel such as converting or amplifying a band of the signal. That is, the RF processing unit 6-10 up-converts a baseband signal provided from the baseband processor 6-20 into an RF band signal and then transmits the converted signal through an antenna, and down-converts an RF band signal received through the antenna into a baseband signal. For example, the RF processing unit 6-10 may include a transmission filter, a reception filter, an amplifier, a mixer, an oscillator, a DAC, and an ADC. Although FIG. 6 illustrates only one antenna, the first access node may include a plurality of antennas. The RF processing unit 6-10 may include a plurality of RF chains. The RF processing unit 6-10 may perform beamforming. For the beamforming, the RF processing unit 6-10 may control the phase and the size of each of the signals transmitted and received through a plurality of antennas or antenna elements. The RF processing unit may perform a downlink MIMO operation by transmitting one or more layers.

The baseband processing unit 6-20 performs a function of performing conversion between a baseband signal and a bitstream according to a physical-layer standard of the first radio-access technology. For example, in data transmission, the baseband processing unit 6-20 generates complex symbols by encoding and modulating a transmission bitstream. Further, in data reception, the baseband processing unit 6-20 reconstructs a reception bitstream by demodulating and decoding a baseband signal provided from the RF processing unit 6-10. For example, in an OFDM scheme, when data is transmitted, the baseband processing unit 6-20 may generate complex symbols by encoding and modulating the transmission bitstream, map the complex symbols to subcarriers, and then configure OFDM symbols through an IFFT operation and CP insertion. In addition, in data reception, the baseband processing unit 6-20 divides a baseband signal provided from the RF processing unit 6-10 in units of OFDM symbols, recovers signals mapped with sub-carriers through an FFT operation, and then reconstructs a reception bit string through demodulation and decoding. The baseband processing unit 6-20 and the RF processing unit 6-10 may transmit and receive the signal as described above. Accordingly, each of the baseband processing unit 6-20 and the RF processing unit 6-10 may be referred to as a transmitter, a receiver, a transceiver, a communication unit, or a wireless communication unit.

The backhaul communication unit 6-30 provides an interface for communicating with other nodes within the network. The backhaul communication unit 6-30 converts a bitstream transmitted from the MeNB to another node, for example, an auxiliary base station, a core network, or the like into a physical signal and converts a physical signal received from the other node into a bitstream.

The storage unit 6-40 may store a basic program, an application, configuration information, and the like for the operation of the MeNB. Particularly, the storage unit 6-40 may store information on bearers allocated to the accessed UE, a measurement result reported from the accessed UE, and the like. Further, the storage unit 6-40 may store information which is a reference for determining whether to provide or stop multiple connections to the UE. The storage unit 6-40 provides stored data according to a request from the controller 6-50.

The controller 6-50 controls overall operations of the base station. For example, the controller 6-50 may transmit and receive a signal through the baseband processing unit 6-20 and the RF processing unit 6-10 or through the backhaul communication unit 6-30. Further, the controller 6-50 reads data in the storage unit 6-40 and reads the data. To this end, the controller 6-50 may include at least one processor, such as a multi-connection processor 6-52.

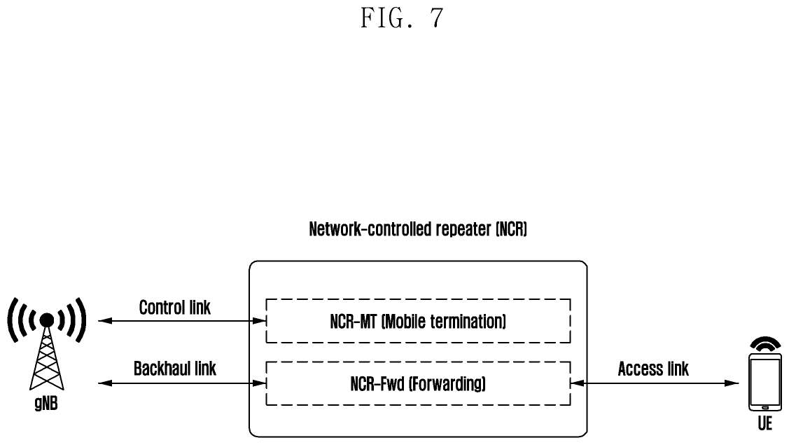

FIG. 7 illustrates the configuration of a network controlled repeater according to an embodiment of the disclosure.

Referring to FIG. 7, according to the development of a wireless communication system, a network controlled repeater (NCR) that selects a desired beam and transmits the beam rather than simply receiving, amplifying, and relaying the existing signal through beam management and control by the base station has been discussed. To this end, not only NCR-forward (FWD) but also NCR-mobile termination (MT) has been introduced to efficiently control beams. The NCR-MT may serve to receive control information for the NCR operation from a serving base station and deliver the control information to the NCR-FWD. The NCR-FWD may serve to amplify an RF signal received from the base station and transmit the RF signal to the UE. The NCR-FWD may perform an additional operation, based on the control information received from the NCR-MT. For example, the NCR-FWD may transfer the amplified signal to the UE and receive a signal transmitted by the UE through a specific beam. Further, the NCR-FWD may not receive/amplify/transfer the signal from the base station according to a specific time-division duplex (TDD) pattern. Similarly, the NCR-FWD may not receive/amplify/transfer the signal from the UE according to a specific TDD pattern. Hereinafter, “NCR-MT” may be interchangeable with “MT” and the “NCR-FWD” may be interchangeable with “FWD”.

The NCR-MT may be an idle mode, and/or an inactive mode. In this case, the NCR-FWD may apply the most recent configuration information received by the NCR-MT operating in a connected mode. The RF signal which the NCR-FWD receives from a serving cell may be configured to be received through some beams on the backhaul connection. In most cases, a control link (C-link) beam may be used as a backhaul link beam.

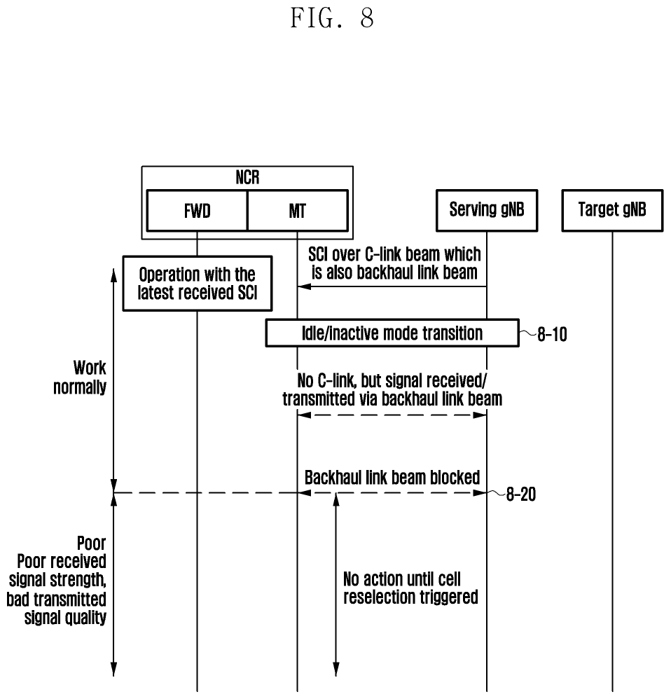

FIG. 8 illustrates a scenario where a backhaul beam is blocked according to an embodiment of the disclosure.

Referring to FIG. 8, since the C-link is released in the idle or inactive mode (8-10) of the MT, operations of measuring beam failure (BF), determining beam failure, and recovering beam failure to manage the backhaul link beam have not been defined. The backhaul link beam of the FWD used for the received signal of the FWD are the same as the beam used in the C-link in most cases, and thus the control of the backhaul link beam and the management operation may be needed to avoid a problem in the operation of the FWD in the state where the C-link is released.

In an example, the backhaul link beam may be blocked (8-20) regardless of the connected mode, the idle mode, or the inactive mode of the MT. According to the existing method, cell reselection may be performed as a method of processing deterioration of the connection quality in the idle/inactive mode of the MT. However, when a specific beam is blocked, the cell selection may be inefficient. For example, when another backhaul link beam still has a good signal but only the current backhaul beam has degraded, cell-level signal comparison metric may be still in a good state, and thus the cell reselection may not be triggered. Accordingly, the network may continuously use the degraded backhaul beam without recognizing the backhaul beam problem, which may cause radio link failure (RLF) or data transmission interruption of the UE.

When the backhaul beam is blocked, a beam failure-related procedure and a cell reselection procedure may be considered as a method of processing the backhaul beam blockage.

In an example, beam failure may be declared on a MAC sublayer of the MT (or UE). For example, when a preset number of beam failure indications are successively transmitted from a physical layer to a higher layer for a preset time, beam failure may be declared. When beam failure is declared, the MT (or UE) may inform the network that the beam failure has occurred through a random access operation. In this case, according to the MT (or UE), a MAC control element (CE) informing of the beam failure may be included in msg 3 and transmitted. The network may receive the random access preamble or recognize the generation of the beam failure, based on the MAC CE in msg3. Thereafter, when the random access procedure is completed, the network may perform an operation of replacing the beam with a specific beam.

In an example, in the case of cell reselection, in the idle or inactive mode, the MT (or UE) may move to a cell having a higher priority and satisfying serving cell metric, based on cell reselection-related metric of the serving cell pre-provided to the MT (or UE) and priority configuration values for the frequency of serving cell and other frequencies.

The disclosure discloses a method of introducing the beam failure-related operation to the backhaul of the MT in the idle/inactive state (method 1) and a method of introducing the cell reselection-related operation to the backhaul of the MT in the idle/inactive state (method 2).

Method 1: the MT may perform a backhaul beam failure detection (BFD) operation and a backhaul beam failure recovery (BFR) operation in the idle/inactive state regardless of the cell reselection operation. Through the BFR, the current serving cell (or serving base station) may recognize a situation where beam failure is detected and indicate an additional operation such as a beam change to the MT. Alternatively, the serving cell (or serving base station) may perform radio access network (RAN)-based paging to the MT. When the serving cell (or serving base station) performs paging, the MT may perform connection resume/setup to perform a beam change operation and/or receive configuration information for a new FWD operation (for example, side control information (SCI)) to control the FWD, according to the paging.

Method 2: the MT (or UE) may receive in advance configuration information for BFD in the backhaul as a factor of the cell reselection. For example, the MT may receive the configuration information for BFD in the backhaul through system information of the serving cell. Thereafter, when beam failure is detected in the idle/inactive state of the MT, the MT may perform the cell reselection operation and move to another cell. Subsequently, the MT may perform the connection resume/setup operation to receive information on a new beam and/or new SCI.

A detailed operation of the aforementioned methods is described below.

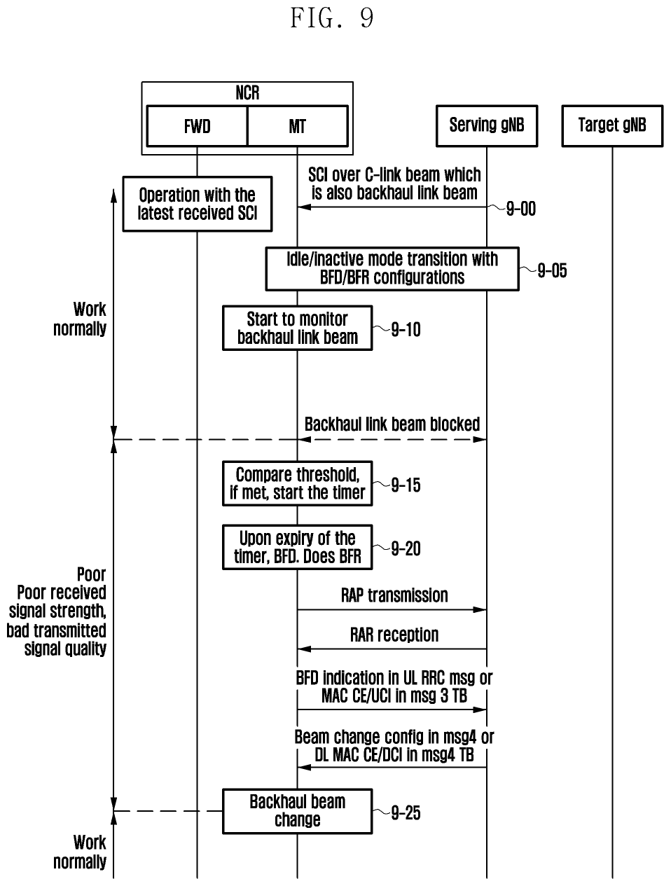

FIG. 9 illustrates method 1-1 of the disclosure according to an embodiment of the disclosure.

Referring to FIG. 9, in method 1-1, the network may transfer (minimized) beam monitoring configuration information to the MT. The configuration information may include information for beam failure detection based on reference signal received power (RSRP) and/or reference signal received quality (RSRQ). When the MT detects beam failure according to the configuration information, the MT may perform random access or transition to the connected mode.
The serving base station may transfer an RRCReconfiguration, RRCRelease, or RRCRelease with suspendConfig message including at least one piece of the following information for each category to the UE (operation 9-00).
Beam monitoring configuration information (On beam monitoring configuration)
A RSRP and/or RSRQ threshold value of beam configured to be measured
A timer value indicating a measurement and evaluation period
Explicit beam information
In the connected mode, a transmission configuration indication (TCI) state ID of a specific beam among beams configured in the C-link and/or resources for bream failure detection (beam monitoring) and/or a resource set ID, and/or information on a bandwidth part (BWP) having an RS corresponding to the corresponding beam
When the information is configured as “absent”, the MT may recognize that the most recently configured backhaul beam (DL and/or UL) in the connected state is a beam for BFD.
In the NCR idle/inactive mode, configuration information for BFR according to BF detection.
rootsequence index for preamble for RACH: an integer value and an id indicating an RACH preamble for BFR in the idle/inactive mode of the NCR-MT
rach-configBFR-NCR (or RACH-ConfigGeneric): time/frequency resource information for RACH preamble transmission when the NCR-MT performs BFR in the idle/inactive mode
rsrp-ThresholdSSB-NCR: for candidate beams having threshold values larger than this threshold value, the MT may use candidate frequency re-selection algorithm (CFRA)
candidateBeamRsList: a list of (synchronization signal blocks (SSBs) or CSR-RSs) for beam measurement, each index (SSB index or channel state information reference signal (CSI-RS) resource set/resource ID) for each reference signal (RS) type, ra-occasion indicated as an integer, an ra-preamble index for each RS
Among RSs configured for BFR or BFD in the disclosure, the CI-RS may be a cell-specific CSI-RS rather than an MT-UE-specific RS
Ssb-perRACH-Occasion: this configuration is followed for rach occasion if the candidate beam RS is an SSB.
Beam failure recovery timer: CFRA can be applied only during this timer
The configuration information may be transmitted through MT/UE-dedicated signaling, or transmitted through system information in the case of cell-specific configuration information. In this case, configuration information which the MT receives through dedicated signaling may take precedence over the configuration information received through the system information.
When the MT transitions to the idle or inactive mode after receiving the configuration (operation 9-05), the MT may measure the indicated beam according to the corresponding information or the indicated backhaul link beam in the connected mode (operation 9-10).
The beam monitoring configuration information and the configuration information of BFR may not be deleted from the configuration of the MT and/or may be stored in a separate storage variable (UE variable) when the MT transitions to the inactive mode.
When the measured beam signal strength becomes lower than or equal to a configured (or predetermined) threshold value while measured by the MT, the MT may start the configured timer (operation 9-15).
When the beam signal strength is continuously maintained to be lower than or equal to the threshold value until the timer expires, the MT may determine that the backhaul beam is not valid any more. That is, the MT may consider that beam failure has occurred (operation 9-20). When beam failure occurs, the MT may perform random access according to preset BFR configuration information and inform the serving base station that the beam failure is detected in the idle/inactive mode of the NCR-MT.
In the random access procedure, a MAC CE including an indicator indicating BFD in the idle/inactive mode of the NCR-MT may be included in msg3. Alternatively, the indicator may be included in a UL RRC message or a MAC CE/DCI included in msg 3.
Alternatively, if the MT supports small data transmission (SDT), the MT may insert the indicator indicating the BFD in the idle/inactive mode of the NCR-MT into the UL RRC message transmitted in msg 3, the MAC CE in the TB, or a PUCCH/UCI by using a UL grant included in an RAR to transmit the same.
When the MT informs the serving base station of detection of the beam failure in the idle/inactive mode of the NCR-MT according to one of the methods, not only the indicator but also measurement strength results of other beams in the serving cell and corresponding beam IDs may be also included and transferred to the serving base station.
If the network pre-configures RA configuration information for NCR-specific BFR in the MT (or UE), the network may recognize that the BFD occurs in the idle/inactive state of the MT when an RA preamble (RAP) received from the corresponding MT and/or RAP transmission resources are preconfigured. Alternatively, when the BFD indicator is included in msg 3 during the RA procedure, the network may recognize that the BFD occurs in the idle/inactive state of the MT, based on the BFD indicator. At this time, the backhaul beam having the BFD may be a backhaul beam configured in the connected mode or may be a beam configured to be monitored by the MT during transition to the idle/inactive mode. If RA and msg 3 transmission correspond to the SDT in the previous operation, the serving baes station may continue an SDT session and transfer a beam change configuration/indication by using msg 4 or SDT DL resource allocation thereafter. At this time, msg 4 or the beam change configuration/indication thereafter may be transmitted through a DL RRC message and/or a DL MAC CE, and/or DCI.
At this time, the beam change configuration/indication may include a beam ID or a TCI state ID for the change, and/or SSB index information related to each beam among the beams configured in the MT in the connected mode.
When the MT receives the beam change configuration/indication, the MT may change the backhaul beam to the corresponding bream and perform an FWD operation, based on the changed beam (operation 9-25).

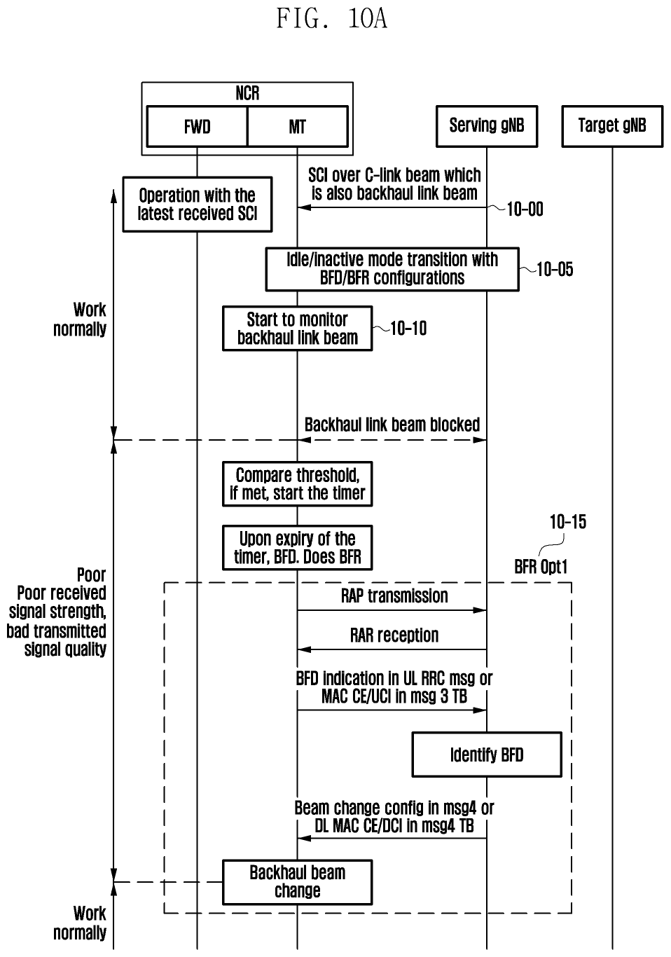

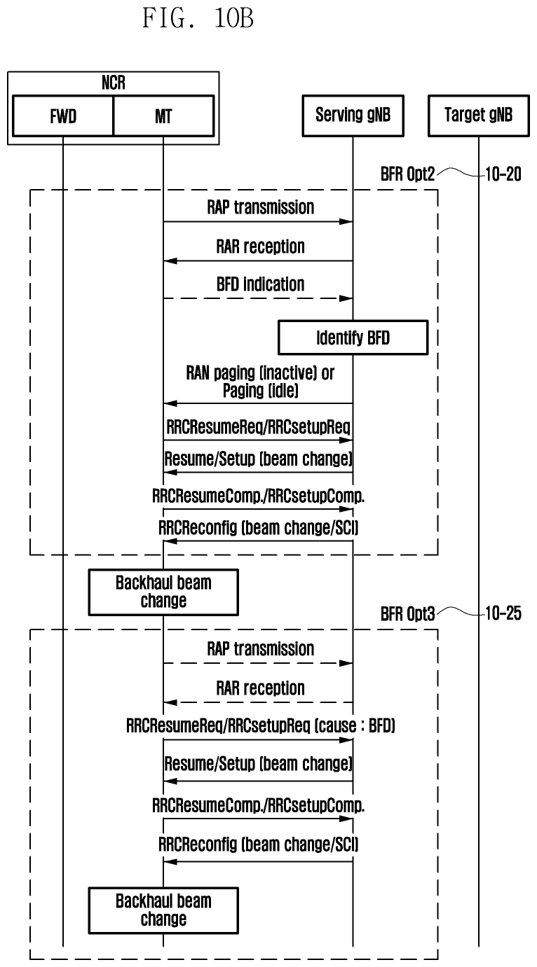

FIGS. 10A and 10B illustrate method 1-2 of the disclosure according to various embodiments of the disclosure.

Referring to FIGS. 10A and 10B, in method 1-2, the serving base station may transmit BFD (based on a physical layer indication) and BFR-related configuration information to the UE. Further, the MT may measure (or monitor) the backhaul, based on information configured in the idle/inactive mode. If BFD occurs, the MT may perform BFR, and the network may transfer an additional configuration/command to the MT.
The serving base station may transfer BFD-related configuration information to the NCF-MT (operation 10-00). At this time, the BFD-related configuration information may be transmitted to the MT while being included in an RRCReconfiguration, RRCrelease, or RRCRelease with SuspendConfig message.
For NCR-BFR-idle/inactive, the BFR-related configuration information may include at least one piece of the following information.
Beam failure detection RS: a type (SSB or CS-RS), an SSB index, CSI-RS resources and/or a resource set ID, a TCI state ID, and a BWP at which an RS/beam is located
A beam failure instance max count value (beamFailureInstance Max count value)
A beam failure detection timer (beamFailureDetectionTimer)
An indicator for reusing configurations given in the connected mode, the MT may reuse the existing parameter for BFD without the configurations.
For NCR-BFR-idle/inactive, the BFR-related configuration information may also include at least one piece of the following information.
rootsequence index for preamble for RACH: an integer value and an id indicating an RACH preamble for BFR in the idle/inactive mode of the NCR-MT
rach-configBFR-NCR (or RACH-ConfigGeneric): time/frequency resource information for RACH preamble transmission when the NCR-MT performs BFR in the idle/inactive mode
rsrp-ThresholdSSB-NCR: for candidate beams having threshold values larger than this threshold value, the MT may use CFRA
candidateBeamRsList: a list of (SSBs or CSR-RSs) for beam measurement, each index (SSB index or CSI-RS resource set/resource ID) for each RS type, ra-occasion indicated as an integer, an ra-preamble index for each RS
Ssb-perRACH-Occasion: this configuration is followed for rach occasion if the candidate beam RS is an SSB.
A beam failure recovery timer: CFRA can be applied only during this timer
The configuration information may be transmitted through MT/UT-dedicated signaling, or transmitted through system information in the case of cell-specific configuration information. In this case, configuration information which the MT receives through dedicated signaling may take precedence over the configuration information received through the system information.
When transitioning to the inactive or idle mode (operation 10-05), the MT may monitor configured RSs/beams (operation 10-10). If beam failure is identified in the RSs/beams, the MT may discover available candidate beams as configured above. If the MT discovered the available candidate beams, the MT may perform CFRA according to the given configuration. Otherwise, the MT may perform candidate beam re-selection algorithm (CBRA) according to the given configuration. The CBRA configuration may not exist in the container but may be included in an SIB of the camped cell.
In the random access procedure, a MAC CE including an indicator indicating BFD in the idle/inactive mode of the NCR-MT may be included in msg3. Alternatively, the indicator may be included in a UL RRC message or a MAC CE/DCI included in msg3.
Alternatively, if the MT supports small data transmission (SDT), the MT may insert the indicator indicating the BFD in the idle/inactive mode of the NCR-MT into the UL RRC message transmitted in msg 3, the MAC CE in the TB, or a PUCCH/UCI to transmit the same.
When the MT informs the serving base station of detection of the beam failure in the idle/inactive mode of the NCR-MT according to one of the methods, not only the indicator but also measurement strength results of other beams in the serving cell and corresponding beam IDs may be also included and transferred to the serving base station.
The serving base station may perform one or a combination of the following operations.
[Option 1: direct beam change (10-15)] like in method 1-1, the network may identify an RA preamble for NCR-specific BFR (if configured) or recognize that beam failure occurred in the most recently configured backhaul beam for NCR-FWD, based on the BFD indicator included in msg 3. Thereafter, the network may continue the SDT session and transfer a beam change configuration/indication to the MT through a DL RRC message and/or a DL MAC, and/or a DL MAC, and/or DL transmission including DCI. The beam change configuration/indication may include a beam ID and/or a TCI state ID for the change among the configurations made through RRC in the connected mode.
When the beam change configuration/indication is received, the MT may change the backhaul beam and use the backhaul beam for FWD.
[Option 2: paging (10-20)] the network may identify an RA preamble for NCR-specific BFR (if configured) or recognize that beam failure occurred in the most recently configured backhaul beam for NCR-FWD, based on the BFD indicator included in msg 3. The network may perform RAN paging (when the MT is in the inactive mode) or perform paging (when the MT is in the idle mode) together with a BFR cause value.
The MT receiving the paging may perform connection resume/setup in the camped cell. The camped cell may be the same as the serving cell.
The cell may configure a beam change or a change in side control information in the connected mode.
[Option 3: MT state change (10-25)] when the MT used SDT to perform BFR in the previous operation, if a UL grant is received, the MT may transmit RRCResumeRequest (when the MT is in the inactive mode) or RRCSetupRequest (when the MT is in the idle mode) by using the corresponding UL grant and a UL grant thereafter. At this time, the cause value indicating BFD may be included in the message.

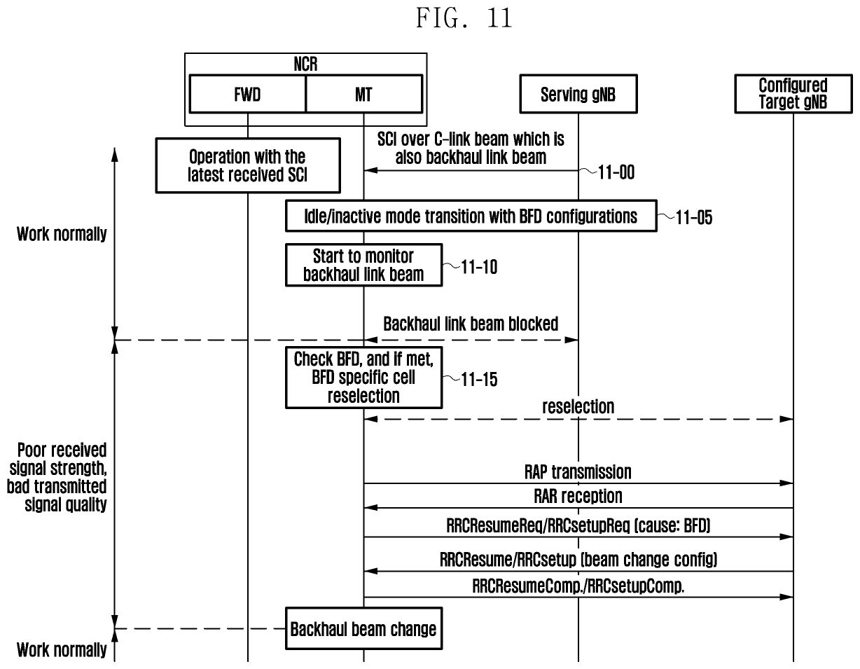

FIG. 11 illustrates method 2 according to an embodiment of the disclosure.

Referring to FIG. 11, in method 2, the MT may perform a cell reselection operation when beam failure is detected.
The serving base station may transfer BFD configuration

information to the MT (operation 11-00). At this time, BFD-related configuration information may include configuration information considered in method 1-1 or method 1-2. The BFD-related configuration information may be broadcasted as system information in the serving cell or transferred to the MT through dedicated signaling in the connected mode.
Option A: when BFD-related configuration information is broadcasted through system information, beam configuration subject to the BFD may be limited not only to a separate RS or TCI state ID but also a backhaul beam configured in the previous connected mode. The BFD-related configuration information of the system information may include an indicator indicating measurement of the backhaul beam configured in the previous connected mode.
Option B: the BFD configurations mentioned in method 1 may be applied. The serving base station may also transfer BFD-related configuration information required for dedicated signaling (for example, a DL RRC message) to the MT. In this case, a specific backhaul beam may be indicated by a TCI state ID, an SSB index, a resource ID of a cell-specific CSI-RS, and/or a resource set ID and transferred to the MT. Further, the BFD-related configuration information may include an indicator indicating the reuse of the most recently configured beam in the connected mode.
In addition, when BFD occurs, information on a cell selected by cell reselection may be included in the BFD-related configuration information. For example, the following information may be transferred to MT together with the BFD configurations.
Frequency information of the cell to be reselected when BFD of the NCR MT occurs and/or cell information of a specific cell in each frequency (PCI, NR CGI, and/or PLMN information)
After receiving the configurations, the MT may transition to the idle/inactive mode (operation 11-05) and measure the configured backhaul beam (operation 11-10). Based on measurement, the MT may evaluate whether BFD occurs in the configured beam according to the BFD-related configuration information.
If the BFD occurs according to the evaluation, the MT may select a random cell of an associated and configured specific cell or a cell having the best cell signal strength (when only the frequency is configured) or may select a specific cell in a specific frequency and camp the specific cell (when the frequency and the PCI of the frequency are configured) (operation 11-15). At this time, the MT may initiate connection resume/setup after reselecting the cell. Here, BFD may be indicated as a newly defined cause value.
The MT may perform the existing cell reselection operation. For example, when the existing cell reselection condition is satisfied, the MT may perform the existing cell reselection. When a cell reselection condition for BFD is satisfied, the MT may perform selection reselection to select associated candidate cells for BFD regardless of the existing cell reselection.
In an example, degradation of the existing backhaul beam may also cause deterioration of the signal strength of the serving cell. Accordingly, the cell reselection operation may start simultaneously with the occurrence of beam failure. In this case, the MT may prioritize the proposed cell reselection according to the beam failure over the exiting cell reselection operation. When the cell is changed by the existing cell reselection, the FWD operation may need to be changed or turned off, and thus a cell capable of the FWD operation (that is, a specific cell for movement when BFD occurs) may be preferentially reselected if possible.

The methods according to various embodiments described in the claims or the specification of the disclosure may be implemented by hardware, software, or a combination of hardware and software.

The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network-controlled repeater (NCR) node in a wireless communication system, the method comprising:
determining, by an NCR-mobile termination (NCR-MT) entity of the NCR node, degradation of a backhaul link beam, while the NCR-MT entity is in inactive state;
based on the determination, ceasing, by an NCR-forwarding (NCR-Fwd) entity of the NCR node, amplifying and forwarding of radio frequency (RF) signals; and
performing, by the NCR-MT entity, a connection resume procedure.

2. The method of claim 1, further comprising:
transmitting, by the NCR-MT entity, a message including a cause value related to the connection resume procedure.

3. The method of claim 1, further comprising:
in case that a different cell than a last serving cell is selected while the NCR-MT entity is in inactive state, ceasing, by the NCR-Fwd entity, amplifying and forwarding of RF signals.

4. The method of claim 1, further comprising:
receiving, by the NCR-MT entity from a base station, side control information, while the NCR-MT entity is in connected state; and
amplifying and forwarding, by the NCR-Fwd entity, RF signals based on the side control information.

5. The method of claim 4, wherein in case that the NCR-MT entity transitions from connected state to inactive state, the side control information is continuously used for amplifying and forwarding of RF signals.

6. A method performed by a network-controlled repeater (NCR)-mobile termination (MT) entity in a wireless communication system, the method comprising:
determining degradation of a backhaul link beam, while the NCR-MT entity is in inactive state; and
performing a connection resume procedure,
wherein amplifying and forwarding of radio frequency (RF) signals is ceased based on the determination.

7. The method of claim 6, further comprising:
transmitting a message including a cause value related to the connection resume procedure.

8. The method of claim 6, further comprising:
in case that a different cell than a last serving cell is selected while the NCR-MT entity is in inactive state, amplifying and forwarding of RF signals is ceased.

9. The method of claim 6, further comprising:
receiving, from a base station, side control information, while the NCR-MT entity is in connected state,
wherein the side control information is used for amplifying and forwarding of RF signals.

10. The method of claim 9, wherein in case that the NCR-MT entity transitions from connected state to inactive state, the side control information is continuously used for amplifying and forwarding of RF signals.

11. A network-controlled repeater (NCR) node in a wireless communication system, the NCR node comprising:
a transceiver; and
a controller coupled with the transceiver and configured to:
determine, by an NCR-mobile termination (NCR-MT) entity of the NCR node, degradation of a backhaul link beam, while the NCR-MT entity is in inactive state,
based on the determination, cease, by an NCR-forwarding (NCR-Fwd) entity of the NCR node, amplifying and forwarding of radio frequency (RF) signals, and
perform, by the NCR-MT entity, a connection resume procedure.

12. The NCR node of claim 11, wherein the controller is further configured to transmit, by the NCR-MT entity, a message including a cause value related to the connection resume procedure.

13. The NCR node of claim 11, wherein the controller is further configured to in case that a different cell than a last serving cell is selected while the NCR-MT entity is in inactive state, cease, by the NCR-Fwd entity, amplifying and forwarding of RF signals.

14. The NCR node of claim 11, wherein the controller is further configured to:
receive, by the NCR-MT entity from a base station, side control information, while the NCR-MT entity is in connected state; and
amplify and forward, by the NCR-Fwd entity, RF signals based on the side control information.

15. The NCR node of claim 14, wherein in case that the NCR-MT entity transitions from connected state to inactive state, the side control information is continuously used for amplifying and forwarding of RF signals.

16. A network-controlled repeater (NCR)-mobile termination (MT) entity in a wireless communication system, the NCR-MT entity comprising:
a transceiver; and
a controller coupled with the transceiver and configured to:
determine degradation of a backhaul link beam, while the NCR-MT entity is in inactive state, and
perform a connection resume procedure,
wherein amplifying and forwarding of radio frequency (RF) signals is ceased based on the determination.

17. The NCR-MT entity of claim 16, wherein the controller is further configured to transmit a message including a cause value related to the connection resume procedure.

18. The NCR-MT entity of claim 16, wherein in case that a different cell than a last serving cell is selected while the NCR-MT entity is in inactive state, amplifying and forwarding of RF signals is ceased.

19. The NCR-MT entity of claim 16,
wherein the controller is further configured to receive, from a base station, side control information, while the NCR-MT entity is in connected state, and
wherein the side control information is used for amplifying and forwarding of RF signals.

20. The NCR-MT entity of claim 19, wherein in case that the NCR-MT entity transitions from connected state to inactive state, the side control information is continuously used for amplifying and forwarding of RF signals.
